(19) United States
(12) Patent Application Publication
(10) Pub. No.: US 2002/0150690 A1
(43) Pub. Date: Oct. 17, 2002

(54) Coating method for car body

(76) Inventors: Takayuki Matsuoka, Kanuma-shi (JP); Tomonari Koike, Utsunomiya-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/162,571

(22) Filed: Jun. 6, 2002

Related U.S. Application Data
(63) Continuation of application No. 09/784,172, filed on Feb. 16, 2001.

(30) Foreign Application Priority Data
Feb. 17, 2000 (JP) 2000-39337

(51) Int. Cl. B05D 1/36

(52) U.S. Cl. 427/407.1

(57) ABSTRACT

The present invention provides a coating method for a car body in which a color base coating material, a pearl base coating material and a clear coating material are applied on the car body by a 3 coat 1 bake system making use of a 2 coat 1 bake coating line in which applied are a base coating material in the first stage and a clear coating material in the second stage and then two layer coating films thus formed are heated and cured in the same time, wherein the color base coating material and the pearl base coating material are applied in the first stage, and then the clear coating material is applied in the second stage; and subsequently, three layer coating films thus formed are heated and cured at the same time.

This is a continuation application of Ser. No. 09/784,172, filed Feb. 16, 2001, now abandoned.

The present invention relates to a method for applying a color base coating material, a pearl base coating material and a clear coating material on an outside plate part of a car body by 3 coat 1 bake using a 2 coat 1 bake coating line.

It is already known to form a top coating film by a so-called “2 coat 1 bake system” (2C1B) in which an electrodepositable coating material and an intermediate coating material are applied on an outside plate part of a car body and baked and then a metallic coating material and a clear coating material as top coating materials are applied thereon and heated to cure top coating films of two layers thus formed at the same time. In recent years, in order to elevate a decorative design, plural layer top coating films are formed by a so-called “3 coat 1 bake system” (3C1B) in which a color base coating material, a pearl base coating material and a clear coating material are applied on an outside plate part of a car body by wet-on-wet and three layer coating films thus formed are heated and cured at the same time.

To be specific, 2C1B is a system in which respectively applied are a metallic coating material usually in the first stage and a clear coating material in the second stage and then two layer coating films thus formed are heated and cured at the same time. Also, 3C1B is a system in which respectively applied are a color base coating material in the first stage, a pearl base coating material in the second stage and a clear coating material in the third stage and then three layer coating films thus formed are heated and cured at the same time. Among them, 3C1B requires the first to third stages in order to apply three kinds of the coating materials.

Further, it has been tried to apply three kinds of the coating materials described above making use of the coating line of 2C1B. This system comprises, to be specific, a step of so-called 3 coat 2 bake (3C2B) in which a color base coating material is applied in the first stage and passed through a heating furnace as it is to be cured; then, it is returned again to the first stage, and a pearl base coating material is applied on the cured color base coating film; subsequently, a clear coating material is applied in the second stage and passed again through the heating furnace to cure both coating films of the pearl base coating material and the clear coating material.

However, the 3C2B system described above in which three kinds of the coating materials are applied making use of the coating line of 2C1B has one more baking step as compared with that of 3C1B and therefore involves the problems that it is not economically preferred.

A principal object of the present invention is to provide a method for applying a color base coating material, a pearl base coating material and a clear coating material on an outside plate part of a car body by 3 coat 1 bake system (3C1B) making use of the coating line of 2C1B.

Intensive researches repeated by the present inventors in order to achieve the object described above have resulted in finding that the object described above can be achieved by applying both color base coating material and pearl base coating material in the first stage of 2C1B, and they have come to complete the present invention.

Thus, according to the present invention, provided is a coating method for a car body in which a color base coating material, a pearl base coating material and a clear coating material are applied on the car body by a 3 coat 1 bake system making use of a 2 coat 1 bake coating line in which applied are a base coating material in the first stage and a clear coating material in the second stage and then two layer coating films thus formed are heated and cured at the same time, wherein the color base coating material and the pearl base coating material are applied in the first stage, and then the clear coating material is applied in the second stage; and subsequently, three layer coating films thus formed are heated and cured at the same time.

The coating method of the present invention shall be explained below in further details.

Car bodies which are to be coated in the present invention include, for example, outside plate parts of a car body such as doors, fenders, panel trunk lids, panel roofs, panel foods (bonnet foods), aprons, bumpers and pillars of passenger cars, light cars and buses. Materials of these car body outside plate parts may be either metals or plastics. These car bodies are suitably coated preferably with an under coating material such as a cationically electrodepositable coating material and a conventional intermediate coating material prior to coating according to the present invention, and the coating films thereof are preferably cured in advance.

The “color base coating material” is a coating material which is applied, prior to coating of a pearl base coating material, directly on a car body or an article to be coated obtained by applying an under coating material and, if necessary, an intermediate coating material, and a conventionally known coating material comprising a resin component, a color pigment and an organic solvent can usually be used. The above resin component includes, for example, a composition comprising a base resin such as an alkyd resin, a polyester resin and an acryl resin each having a cross-linking functional group such as a hydroxyl group and a cross-linking agent such as a melamine resin and a (blocked) polyisocyanate compound. Solid color pigments for chromatic and achromatic coating materials can suitably be used as the color pigment. Use of metallic pigments such as an aluminum pigment in a small amount in combination with these color pigments can elevate a hiding property of the color base coating material. Capable of being used as the organic solvent are conventional organic solvents for a coating material such as hydrocarbons, alcohols, esters, ketones and ethers.

Such color base coating material is preferably controlled so that a solid content falls in a range of usually 10 to 60% by weight, particularly 15 to 25% by weight, and a viscosity falls in a range of usually 10 to 30 seconds/Ford cup #4/20° C., particularly 11 to 13 seconds/Ford cup #4/20° C. in coating. Further, it has preferably such a hiding power that a color tone of the coated surface is hided by the resulting colored coating film.

The “pearl base coating material” is a coating material which is applied on an uncured coated surface of the color base coating material described above according to the present invention, and a conventionally known liquid coating material comprising a resin component, a pearl pigment and an organic solvent and forming a photo-coherent pearl tone coating film can usually be used therefor. The above resin component includes, for example, a composition comprising a base resin such as an alkyd resin, a polyester resin and an acryl resin each having a cross-linking functional group such as a hydroxyl group and a cross-linking agent such as a melamine resin and a (blocked) polyisocyanate compound. Pigments having a photocoherency, for example, flaky mica powder covered with titanium oxide can suitably be used for the pearl pigment. A blending proportion of the pearl pigment falls suitably in a range of usually 5 to 100 parts by weight, particularly 8 to 50 parts by weight per 100 parts by weight (solid matters) of the resin component. Capable of being used as the organic solvent are conventional organic solvents for a coating material such as hydrocarbons, alcohols, esters, ketones and ethers.

Such pearl base coating material is preferably controlled so that a solid content falls in a range of usually 10 to 60% by weight, particularly 15 to 25% by weight, and a viscosity falls in a range of usually 10 to 30 seconds/Ford cup #4/20° C., particularly 11 to 13 seconds/Ford cup #4/20° C. in coating. Further, a pearl tone coating film formed from the pearl base coating material has preferably an insufficient hiding power to such an extent that a color tone of the coating film of the color base coating material on the coated surface can be looked through.

The “clear coating material” is a coating material which is applied on an uncured coated surface of the pearl base coating material described above, and a conventionally known liquid coating material comprising a resin component and an organic solvent and forming a colorless or colored transparent coating film can be used therefor. The above resin component includes, for example, a composition comprising a base resin such as an alkyd resin, a polyester resin and an acryl resin each having a cross-linking functional group such as a hydroxyl group and a cross-linking agent such as a melamine resin and a (blocked) polyisocyanate compound. Capable of being used as the organic solvent are conventional organic solvents for a coating material such as hydrocarbons, alcohols, esters, ketones and ethers. Further, the above clear coating material can contain a color pigment or a dye of such an amount that it does not substantially damage a transparency of the coating film formed. Such clear coating material is preferably controlled so that a solid content falls in a range of usually 30 to 60% by weight, particularly 40 to 50% by weight, and a viscosity falls in a range of usually 10 to 30 seconds/Ford cup #4/20° C., particularly 20 to 30 seconds/Ford cup #4/20° C. in coating.

The present invention provides a method for applying three kinds of the coating materials described above on a car body by a 3 coat 1 bake system making use of a 2 coat 1 bake coating line in which applied are a base coating material in the first stage and a clear coating material in the second stage and then two layer coating films thus formed are heated and cured at the same time, and it is characterized by that both of the color base coating material and the pearl base coating material are applied in the first stage.

In the 2 coat 1 bake coating line, usually disposed in the first stage are each one reciprocating type automatic coating apparatus for coating horizontal parts of a car body and reciprocating type automatic coating apparatus for coating vertical parts thereof, and these respective apparatuses are equipped with each at least two coating material-spraying nozzles. In this case, examples of the horizontal parts of the car body include panel trunk lids, panel roofs, panel foods (bonnet foods) and pillars, and examples of the vertical parts include doors, fenders, aprons and bumpers.

In the first stage, at least one of the spraying nozzles installed in the respective reciprocating type automatic coating apparatuses is positioned preferably at a carrying-in side of a car body in the coating line, and at least one of them is positioned preferably at a carrying-out side thereof. In the present invention, they are preferably installed so that sprayed and applied respectively are the color base coating material from the spraying nozzle at the carrying-in side of the car body and the pearl base coating material from the spraying nozzle at the carrying-out side thereof. That is, installing them in such manner makes it possible to spray and apply the color base coating material and the pearl base coating material at the same time by means of a single reciprocating type automatic coating apparatus, which results in making it possible to apply first the color base coating material on an outside plate part of a car body in the course of carrying it in the coating line in the first stage and then the pearl base coating material on the coated surface thereof by wet-on-wet.

The color base coating material and the pearl base coating material are applied on the horizontal parts and the vertical parts by means of the spraying nozzles installed in the reciprocating type automatic coating apparatuses in the first stage, and a coating method thereof includes, to be specific, airless spraying, air spraying and electrostatic coating. A coating amount of the coating materials shall not be restricted to a narrow range and can be changed according to the kind of a coated article. In general, it falls suitably in a range of 5 to 30 μm, particularly 10 to 20 μm in terms of a cured film thickness in the case of the color base coating material and 5 to 30 μm, particularly 10 to 20 μm in terms of a cured film thickness in the case of the pearl base coating material. Time interval passing from applying of the color base coating material to applying of the pearl base coating material is short (for example, 1 to 30 seconds), and therefore in order to prevent pin holes, inferior finishing and mixing of layers from being caused, a solvent which is quickly vaporized and has a good solubility is preferably used as the organic solvent for the color base coating material and the pearl base coating material at an optimum coating viscosity and a controlled solid content of the coating materials coated. To be specific, capable of being suitably used are conventional solvents for a coating material such as toluene, xylene, methanol and ethyl acetate having boiling points falling in a range of about 80 to about 110° C.

In the present invention, the color base coating material and the pearl base coating material are applied on the horizontal parts and the vertical parts by wet-on-wet in the manner described above in the first stage using the 2 coat 1 bake coating line, and then it is transferred to the second stage to apply the clear coating material there.

The clear coating material can be applied in the same manner as carried out in the second stage of a conventional 2 coat 1 bake coating line. Disposed are each one reciprocating type automatic coating apparatus for coating horizontal parts and reciprocating type automatic coating apparatus for coating vertical parts in the second stage, and these respective apparatuses are equipped with each at least one coating material-spraying nozzle. In the second stage, the clear coating material is sprayed from the reciprocating type automatic coating apparatus onto an outside plate part of a car body in the course of carrying it in the coating line by a conventionally known method. An applying amount thereof shall not be restricted to a narrow range and can be changed according to the kind of a coated article. In general, it falls suitably in a range of 20 to 60 μm, particularly 30 to 45 μm in terms of a cured film thickness.

The car body coated by wet-on-wet on the horizontal parts and the vertical parts in the outside plate part of the car body with the color base coating material, the pearl base coating material and the clear coating material in the manner described above is then carried to a heating furnace in the 2 coat 1 bake coating line. The car body is baked there at a temperature of usually about 120 to about 170° C., particularly about 130 to about 160° C. for not much longer than 10 to 40 minutes to cure a three layer coating film comprising the respective coating materials described above, whereby the coating method for a car body according to the present invention can be achieved.

According to the method of the present invention described above, the color base coating material, the pearl base coating material and the clear coating material can be applied on an outside plate part of a car body by a 3 coat 1 bake system making use of facilities in a 2 coat 1 bake coating line without almost correcting them, and the coating cost can be cut to a large extent.

The present invention shall be explained below in further details with reference to examples.

### EXAMPLE 1

A color base coating material, a pearl base coating material and a clear coating material each described below were applied on a car body (made of a steel plate) on which a cationically electrodepositable coating material and an intermediate coating material were applied by a 3 coat 1 bake system using a 2 coat 1 bake coating line and heated and cured.

Color base coating material: white color organic solvent type coating material comprising a hydroxyl group-containing polyester resin, a melamine resin, a titan white pigment and aluminum flakes. Used as the organic solvent was a toluene/xylene/methanol/ ethyl acetate mixed solvent having a boiling point of about 80 to 110° C. A Munsell color chart N value of the coating film: 8.0; a solid content: 35% by weight; and a viscosity: 12 seconds/Ford cup #4/20° C.

Pearl base coating material: photo-coherent organic solvent type coating material comprising a hydroxyl group-containing polyester resin, a melamine resin and titanium oxide-covered mica flakes. A solid content: 35% by weight, and a viscosity: 12 seconds/Ford cup #4/20° C. Used as the organic solvent was a toluene/xylene/methanol/ethyl acetate mixed solvent having a boiling point of about 80 to 110° C.

Clear coating material: organic solvent type coating material comprising a hydroxyl group-containing acryl resin and a melamine resin. A solid content: 35% by weight, and a viscosity: 20 seconds/Ford cup #4/20° C.

The operation conditions of the reciprocating type automatic coating apparatuses for the horizontal parts and the vertical parts for applying the color base coating material and the pearl base coating material in the first stage were a conveyer speed of a coated article: 1.5 m/second, a reciprocating width of 1.0 m, a reciprocating speed of 51 m/minute, an air amount of an REA electrostatic coating gun (atomization/pattern): 2.5/3.0 kg/cm³, a distance from a head of the coating apparatus to a coated surface: 250 mm, a voltage of −60 KV and a coating material discharging amount of 300 ml/second.

The operation conditions of the reciprocating type automatic coating apparatuses for the horizontal parts and the vertical parts for applying the clear coating material in the second stage were a conveyer speed of a coated article: 1.5 m/second, a reciprocating width of 1.0 m, a reciprocating speed of 51 m/minute, a revolution of an electrostatic coating bell: 25,000 revolutions/minute, a distance from a head of the coating apparatus to a coated surface: 250 mm, a voltage of −60 KV and a coating material-discharging amount of 200 ml/second.

The color base coating material and the pearl base coating material were applied on the horizontal parts and the vertical parts of a car body on the conditions described above by means of the reciprocating type automatic coating apparatuses in the first stage of a coating line, and then the clear coating material was applied thereon on the conditions described above in the second stage. Thereafter, they were carried in a heating furnace and baked at 140° C. for 30 minutes to cure the resulting three layer coating films at the same time.

The plural layer coating film thus formed showed the same or higher performances in terms of smoothness, clarity and a decorative design (color feeling, pearl feeling) as compared with those of films coated by a 3 coat 1 bake system in a 3 coat coating line and those of films coated by a 3 coat 2 bake system in a 2 coat coating line.

1. A coating method for a car body in which a color base coating material, a pearl base coating material and a clear coating material are applied on the car body by a 3 coat 1 bake system making use of a 2 coat 1 bake coating line in which applied are a base coating material in the first stage and a clear coating material in the second stage and then two layer coating films thus formed are heated and cured in the same time, wherein the color base coating material and the pearl base coating material are applied in the first stage, and then the clear coating material is applied in the second stage; and subsequently, three layer coating films thus formed are heated and cured at the same time.

2. The coating method for a car body as described in claim 1, wherein installed is each one reciprocating type automatic coating apparatus for coating horizontal parts and vertical parts of the car body equipped with two or more coating material-spraying nozzles; respectively sprayed and applied are the color base coating material from at least one spraying nozzle at a carrying-in side of the car body and the pearl base coating material from at least one spraying nozzle at a carrying-out side of the car body.

3. The coating method for a car body as described in claim 1, wherein the color base coating material has a solid content of 10 to 60 % by weight and a viscosity of 10 to 30 seconds/Ford cup #4/20° C.

4. The coating method for a car body as described in claim 1, wherein the color base coating material is applied in a thickness of 5 to 30 μm in terms of a cured film thickness.

5. The coating method for a car body as described in claim 1, wherein the pearl base coating material has a solid content of 10 to 60 % by weight and a viscosity of 10 to 30 seconds/Ford cup #4/20° C.

6. The coating method for a car body as described in claim 1, wherein the pearl base coating material is applied in a thickness of 5 to 30 μm in terms of a cured film thickness.

7. The coating method for a car body as described in claim 1, wherein the color base coating material and the pearl base coating material contain an organic solvent having a boiling point of about 80 to about 110° C.

8. The coating method for a car body as described in claim 1, wherein the color base coating material and the pearl base coating material are applied in the first stage; then, the clear coating material is applied on the horizontal parts and the vertical parts of the car body by means of the reciprocating type automatic coating apparatuses in the second stage; and the three layer coating films formed are heated and cured at the same time.

9. The coating method for a car body as described in claim 1, wherein the clear coating material has a solid content of 30 to 60% by weight and a viscosity of 10 to 30 seconds/Ford cup #4/20° C.

10. The coating method for a car body as described in claim 1, wherein the clear coating material is applied in a thickness of 20 to 60 μm in terms of a cured film thickness.

11. The coating method for a car body as described in claim 1, wherein the three layer coating film formeds are heated at about 120 to about 170° C. and cured at the same time.

12. A car body coated by the method as described in claim 1.
